(19) United States
(12) Patent Application Publication
(10) Pub. No.: US 2017/0124621 A1
(43) Pub. Date: May 4, 2017

(54) PRODUCT INFORMATION PROVIDING DEVICE, PRODUCT INFORMATION PROVIDING METHOD, PRODUCT INFORMATION PROVIDING SYSTEM, AND NON-TRANSITORY COMPUTER READABLE STORAGE MEDIUM HAVING COMPUTER PROGRAM RECORDED THEREON

(71) Applicant: SK Planet Co., Ltd., Seongnam-si, Gyeonggi-do (KR)

(72) Inventor: Seung Won NA, Seoul (KR)

(21) Appl. No.: 15/317,975

(22) PCT Filed: Jun. 25, 2015
(86) PCT No.: PCT/KR2015/006503

§ 371 Date: Dec. 12, 2016

(30) Foreign Application Priority Data
Aug. 26, 2014 (KR) 10-2014-0111781
Oct. 15, 2014 (KR) 10-2014-0138884

(51) Int. Cl. G06Q 30/06; G06F 17/30

(52) U.S. Cl. CPC G06Q 30/0625; G06Q 30/0605; G06F 17/30867

(57) ABSTRACT

Disclosed are a product information providing device and a product information providing method of an offline store. According to the present invention, it is possible to receive an information request message, obtain a list of products equipped in one or more offline stores based on product information included in the message, extract an effective product from the products by inspecting the list with an inspection item generated based on the product information; and provide information on an effective offline store equipped with an effective product among one or more offline stores and information on the effective product. Information on an effective product which is frequently traded is constructed using product information registered in a database by a search request of a user so that sellers may efficiently make a plan to promote products and create a sales stratagem using the information of the effective product.

### TECHNICAL FIELD

The present invention relates to a product information providing device and a product information providing method of an offline store which, when a user requests information on a desired product for a plurality of offline stores located in a predetermined area, provide information on an offline store equipped with the product and information on the product.

Further, the present invention relates to a product information providing device, a product information providing method, a product information providing system, and a non-transitory computer readable storage medium having a computer program recorded therein which provide information on a location of an offline store in which a product is purchased with respect to a position of a user to a user device.

### BACKGROUND ART

A mobile product searching service of the related art mostly searches and provides online product information. Conceptually, there is no way to search for a product equipped in an offline store. Product information of the offline store may be obtained only by visiting the offline store or by a telephone inquiry.

In order to search for a product of the offline store through the Internet, an offline store in a desired area needs to upload a list of products to a server. However, it is difficult to actually upload all products in the store. Further, it is not desired because all information such as in-stock products, released products, returned products, sold-out products, and products transferred between stores cannot be shared. Further, it is not efficient because data on products which are not popular in the store is also included.

Further, in accordance with development of a mobile communication technique, a wireless device such as a mobile phone or a personal digital assistant (PDA) is explosively used and a service performed in a wired internet environment is gradually shifted to a wireless internet based service.

One of wireless Internet services which attract a lot of attention is M-commerce (mobile-commerce) which is a mobile electronic commerce. The M-commerce refers to a monetary transaction of various information, services, and goods which are performed based on a mobile communication device and a communication network. The mobile electronic commerce is an important service which allows a client and providers to interactively commit transaction at any time in anywhere if necessary.

The M-commerce attracts an attention as a next generation business and a size of markets based on the M-commerce may expand in the future. Currently, many mobile shopping content providers provide various types of services to provide a convenient product searching service to a user. Further, the M-commerce is performed based on a personal mobile device so that a personal commercial transaction may be performed based on customized information.

### RELATED ART DOCUMENT

### Patent Document

Korean Unexamined Patent Application Publication No. 10-2014-0047258, Apr. 22, 2014 (entitled On-offline complex commerce system)

Korean Unexamined Patent Application Publication No. 10-2011-0029374 (entitled Mobile payment service method and system).

### DISCLOSURE

### Technical Problem

An object of the present invention is to construct product information registered in a database by a search request of a user to provide information on an effective product which is frequently traded.

Further, another object of the present invention is to provide information on an offline store equipped with products desired by a user to allow the user to efficiently to check and purchase an actual product without taking much time to visit several stores.

Furthermore, another object of the present invention is to provide a product information providing device, a product information providing method, a product information providing system, and a non-transitory computer readable storage medium having a computer program recorded thereon to provide information on an offline purchasable product by a user with respect to a position of the user.

Furthermore, another object of the present invention is to provide a product information providing device, a product information providing method, a product information providing system, and a non-transitory computer readable storage medium having a computer program recorded thereon to provide payment amount information on different products for every user based on personal payment information of the user.

Furthermore, another object of the present invention is to provide a product information providing device, a product information providing method, a product information providing system, and a non-transitory computer readable storage medium having a computer program recorded thereon to provide an optimal route for offline product purchase of a user with respect to a position of the user.

### Technical Solution

According to an aspect of the present invention, a product information providing device of an offline store includes: a receiving unit which receives an information request message from a terminal device of a user; a list obtaining unit which obtains a list of one or more products equipped in the offline store based on the product information included in the information request message; a product inspecting unit which inspects the list with an inspection item generated based on the product information to extract an effective product from the products; and a providing device which registers the effective product in the database and transmits information on an effective offline store equipped with the effective product among one or more offline stores and information on the effective product to the terminal device.

In an embodiment of the present invention, the product inspection unit may extract a product having a value of a list item corresponding to a main item of the inspection item in the list which is equal to a value of the main item as the effective product, among the products.

In an embodiment of the present invention, the product inspecting unit may extract a product having a value of the list item corresponding to the general item of the inspection item in the list which is the same as the value of the general item as the effective product, among the products.

In an embodiment of the present invention, the inspection item may be constituted by a main item including one or more of a product name, a barcode number, and a product unique identification number and a general item including one or more of a released date, a product price, a manufacturer, a seller, a name of person in charge of releasing, and a product image.

In an embodiment of the present invention, the product inspecting unit may compare the value of the list item corresponding to one or more effective products registered in the database and the value of the inspection item to update the value of the inspection item.

In an embodiment of the present invention, the list obtaining unit may search for one or more offline stores based on the product information within a predetermined area corresponding to the search area information using the search area information which is included in the information request message together with the product information.

In an embodiment of the present invention, the providing unit may transmit information on the effective offline store including one or more of a location of the effective offline store, a phone number, an address, a photograph of the effective offline store, and subsidiary information of the effective offline store to the terminal device.

In an embodiment of the present invention, the product inspecting unit may extract a product having predetermined reference or more values of the list item corresponding to the inspection item in the list which is equal to the values of the inspection item as a similar product, among the products.

In an embodiment of the present invention, the product inspecting unit may change the similar product to any one of the effective product and a registration excluded product which is excluded from being registered in the database in accordance with determination of a database manager.

Further, according to yet another aspect of the present invention, a product information providing method of an offline store includes: receiving an information request message from a terminal device of a user; obtaining a list of one or more products equipped in the offline store based on the product information included in the information request message; extracting an effective product from the products by inspecting the list with an inspection item generated based on the product information; and registering the effective product in the database and transmitting information on an effective offline store equipped with the effective product among one or more offline stores and information on the effective product to the terminal device.

In an embodiment of the present invention, in the extracting, a product having a value of a list item corresponding to a main item of the inspection item in the list which is the same as the value of the main item may be extracted as the effective product, among the products.

In an embodiment of the present invention, in the extracting, a product having a value of a list item corresponding to a general item of the inspection item in the list which is the same as the value of the general item may be extracted as the effective product, among the products.

In an embodiment of the present invention, the inspection item may be constituted by a main item including one or more of a product name, a barcode number, and a product unique identification number and a general item including one or more of a released date, a product price, a manufacturer, a seller, a name of person in charge of releasing, and a product image.

In an embodiment of the present invention, in the extracting, the value of the list item corresponding to one or more effective products registered in the database may be compared with the value of the inspection item to update the value of the inspection item.

In an embodiment of the present invention, in the obtaining of a list, one or more offline stores may be searched based on the product information within a predetermined area corresponding to the search area information using the search area information which is included in the information request message together with the product information.

In an embodiment of the present invention, in the transmitting, information on the effective offline store including one or more of a location of the effective offline store, a phone number, an address, a photograph of the effective offline store, and subsidiary information of the effective offline store may be transmitted to the terminal device.

In an embodiment of the present invention, in the extracting, a product having predetermined reference or more values of the list item corresponding to the inspection item in the list which are equal to values of the inspection item may be extracted as a similar product, among the products.

In an embodiment of the present invention, the extracting may include changing the similar product to any one of the effective product and a registration excluded product which is excluded from being registered in the database in accordance with determination of a database manager.

Further, according to yet another aspect of the present invention, a product information providing system of an offline store includes: a product information providing device which receives an information request message and obtains a list of products equipped in one or more offline stores based on product information included in the message, extracts an effective product from the products by inspecting the list with an inspection item generated based on the product information, and provides information on an effective offline store equipped with the effective product among one or more offline stores and information on the effective product; and a terminal device which transmits the information request message to the product information providing device based on an input of the user and receives information on the effective offline store and information on the effective product corresponding to the information request message from the product information providing device.

Further, according to yet another aspect of the present invention, a product information providing device may include: a product information management unit which manages information on an offline store and information on sale products of the offline store; a product payment information management unit which receives product payment related information from a user device and manages the product payment related information; and a product search result providing unit which receives information on a search target product from the user device, determines purchasable stores which treat the search target product as the sale product among the offline stores, and determines a close offline store located within a predetermined distance range from the user device among the purchasable stores.

In an embodiment of the present invention, the product payment related information may include available payment card information of the user at the time of purchasing the search target product and coupon information.

In an embodiment of the present invention, the close offline store and information on a sale price of the search target product in the close offline store may be provided on a map image, by means of the product information providing device and the sale price may be determined based on the available payment card information and the coupon information.

In an embodiment of the present invention, when there is a plurality of search target products and there is a plurality of close offline stores for each of the plurality of search target products, the product search result providing unit may provide an optimal route to purchase the plurality of search target products.

In an embodiment of the present invention, the optimal route may be determined based on position information of the user device, location information of each of the plurality of close offline stores and converted amount information for distance, and the converted amount for distance may be a correction value of an expected purchase amount according to a distance difference for determining an optimal route.

In an embodiment of the present invention, the optimal route may be determined by comparing an expected purchase amount for a shortest route and an amount obtained by adding the expected purchase amount and a value obtained by multiplying a route difference from the shortest route and the converted amount for distance, when the expected purchase amount is relatively smaller, the optimal route may be determined by the shortest route, and when the amount obtained by adding the expected purchase amount and the value obtained by multiplying a route difference and the converted amount for distance is relatively smaller, the optimal route may be determined by the setting route.

In an embodiment of the present invention, the user device may transmit the converted amount for distance and information on a predetermined distance range to determine the close offline store to the product information providing device.

In an embodiment of the present invention, the product payment information management unit may receive image information of a payment card of the user as the product payment related information and analyzes the image information to obtain card number information of the payment card of the user.

According to still another aspect of the present invention, a product information providing method may include: receiving information on an offline store and information on a sale product of the offline store, by means of a product information providing device, receiving product payment related information from a user device, by means of the product information providing device; and receiving information on a search target product from the user device, determining purchasable stores which treat the search target product as the sale product among the offline stores, and determining a close offline store located within a predetermined distance range from the user device among the purchasable stores, by means of the product information providing device.

In an embodiment of the present invention, the method may further include transmitting related product information related to the search target product to the user device, by means of the product information providing device in which the related product information may be information on a product which is in the same category as the search target product and is provided to another user in an overlapping location within a predetermined period.

According to still another aspect of the present invention, a computer program which executes the method according to the above-described embodiment may be stored in a non-transitory computer readable storage medium having a computer program recorded thereon configured to perform the method according to the embodiment of the present invention.

According to still another aspect of the present invention, a product information providing system may include a product information providing device which receives information on offline stores and sale products of the offline stores, receives product payment related information from a user device, receives information on a search target product from the user device, determines product purchasable stores which treat the search target product as the sale product, among the offline stores, and determines a close offline store located in a predetermined distance range from the user device, among the purchasable stores; and the user device which transmits information on the search target product to the product information providing device and receives information on the close offline store and a sale price of the search target product of the close offline store on a map image from the product information providing device.

### Advantageous Effects

According to the present invention, it is possible to construct product information registered in a database by a search request of a user to provide effective product information which is frequently traded.

Further, according to the present invention, it is possible to provide information on an offline store equipped with products desired by a user to allow a user to efficiently to check and purchase an actual product without taking much time to visit several stores.

Furthermore, according to the present invention, it is possible to provide information on an offline store in which a user purchases a desired product with respect to a position of the user and provide information on an expected payment amount for every user when the user purchases a product in an offline store in consideration of payment information for every user (for example, payment card information or coupon information). Further, it is possible to provide information on an optimal route to allow a user to purchase a product on the offline and allow the user to make a payment on the product through a simpler procedure.

### BRIEF DESCRIPTION OF THE DRAWINGS

FIG. 1 is a block diagram illustrating a product information providing system of an offline store according to an embodiment of the present invention.

FIG. 2 is a block diagram illustrating a product information providing device of an offline store illustrated in FIG. 1.

FIG. 3 is a view illustrating an example of searching for an offline store by an information request of a user according to an embodiment of the present invention.

FIG. 4 is a view specifically illustrating a product information providing system of an offline store according to an embodiment of the present invention.

FIG. 5 is a view illustrating product classification in accordance with an inspection process according to an embodiment of the present invention.

FIG. 6 is a flowchart illustrating an operation of a product information providing method of an offline store according to an embodiment of the present invention.

FIG. 7 is a flowchart specifically illustrating an operation of a product information providing method of an offline store according to an embodiment of the present invention.

FIG. 8 is a conceptual view illustrating a method of providing product information based on a user device according to an embodiment of the present invention.

FIG. 9 is a conceptual view illustrating a product information providing device according to an embodiment of the present invention.

FIG. 10 is a conceptual view illustrating product searching result information according to an embodiment of the present invention.

FIG. 11 is a conceptual view illustrating product searching result information according to an embodiment of the present invention.

FIG. 12 is a conceptual view illustrating an operation of a product payment related information management unit according to an embodiment of the present invention.

FIG. 13 is a conceptual view illustrating a product purchasing method according to an embodiment of the present invention.

FIG. 14 is a conceptual view illustrating a product purchasing method according to an embodiment of the present invention.

FIG. 15 is a conceptual view illustrating an operation of a product information providing server according to an embodiment of the present invention.

### MODE FOR INVENTION

Hereinafter, exemplary embodiments of the present invention will be described in detail with reference to the accompanying drawings. Further, in the following description and the accompanying drawings, a detailed explanation of known related functions and configurations may be omitted to avoid unnecessarily obscuring the subject matter of the present invention. Like reference numerals generally denote like elements throughout the drawings.

Terms or words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. Therefore, configurations illustrated in the embodiments and the drawings described in the present specification are only the most preferred embodiment of the present invention and do not represent all of the technical spirit of the present invention, and thus it is to be understood that various equivalents and modified examples, which may replace the configurations, are possible when filing the present application. Although the terms “first”, “second”, and the like are used for describing various components, these components are not confined by these terms. These terms are merely used for distinguishing one component from the other components.

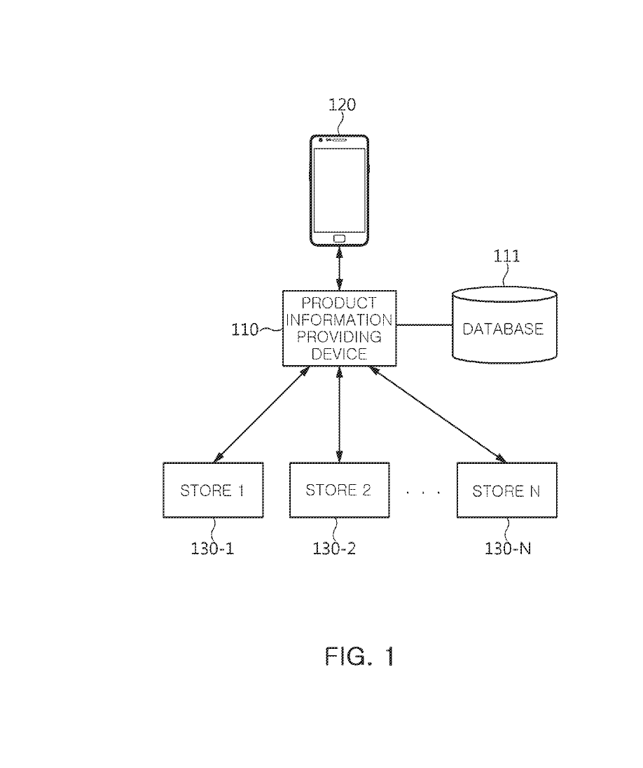

FIG. 1 is a block diagram illustrating a product information providing system of an offline store according to an embodiment of the present invention.

Referring to FIG. 1, a product information providing system of an offline store according to an embodiment of the present invention includes a product information providing device 110, a database 111, a terminal device 120, and offline stores 130-1 to 130-N.

The product information providing device 110 receives an information request message from the terminal device 120 of a user. For example, the product information providing device 110 may receive an information request message which includes one or more of a product name and a unique identification number of a product which are input to the terminal device 120 by the user and a barcode and an image of the product which is recognized by a camera equipped in the terminal device 120.

Further, the product information providing device 110 obtains a list of products equipped in the offline stores 130-1 to 130-N based on product information included in the information request message. In this case, the product information providing device 110 may search for offline stores 130-1 to 130-N based on product information within a predetermined area corresponding to search area information, using the search area information which is included in the information request message together with the product information.

Further, the product information providing device 110 inspects a list with an inspection item created based on the product information to extract effective products among products. In this case, a product having a value of a list item corresponding to a main item of an inspection item in the list which is equal to a value of the main item may be extracted as the effective product, among the products. In this case, a product having a value of a list item corresponding to a general item of the inspection item in the list which is equal to a value of the general item may be extracted as the effective product, among the products. In this case, the inspection item may be constituted by a main item including one or more of a product name, a barcode number, and a product unique identification number and a general item including one or more of a released date, a product price, a manufacturer, a seller, a name of person in charge of releasing, and a product image. In this case, the values of the inspection item may be updated by comparing values of the list item corresponding to one or more effective products registered in the database 111 and the values of the inspection item. Further, a product having predetermined reference or more values of the list item corresponding to the inspection item in the list which are equal to the values of the inspection item may be extracted as a similar product, among the products. In this case, in accordance with determination of a database manager, the similar product may be changed to any one of the effective product and a registration excluded product which is excluded from being registered in the database 111.

Further, the product information providing device 110 registers the effective product in the database 111 and transmits information on an effective offline store equipped with an effective product among the offline stores 130-1 to 130-N and information on the effective product to the terminal device. In this case, the product information providing device 110 may transmit effective offline store information including one or more of a location of the effective offline store, a phone number, an address, a photograph of the effective offline store, and subsidiary information of the effective offline store to the terminal device 120.

The database 111 may register information on a product extracted as an effective product in the product information providing device 110 and information of the effective offline store equipped with the corresponding product. In this case, information on the effective product and the effective offline store may be constructed using the registered information. For example, the information may be constructed by grouping product information according to categories of the products registered in the database 111 or listing effective products according to the number of times of search-requested by the users.

Further, the database 111 is connected to the product information providing device 110 to be solely provided as illustrated in FIG. 1 or included in the product information providing device 110.

The terminal device 120 may receive product information from the user to transmit an information request message to the product information providing device 110. For example, when the user searches for a product using the terminal device, the user may input one or more product information of the product name, the product unique identification number, the barcode, and the product image to search for the product.

In this case, the user may transmit a search area information together with the product information to be included in the information request message. The search area information is information which is generated when the user designates a specific area and searches the corresponding area for a product. The search area information may be used when the product information providing device 110 searches for an offline store in an area corresponding to the search area information. For example, when the user searches for a store in which running shoes are sold in Myungdong, the information request message may be transmitted by setting Myungdong as search area information.

The offline stores 130-1 to 130-N may be stores which are registered in the product information providing device 110 and the database 111 in advance. Further, the offline stores 130-1 to 130-N may transmit/receive data to/from the product information providing device 110 through point of sales (POS) devices equipped in the stores. For example, the product information providing device 110 may transmit the product information received from the user terminal 120 of the user to the POS devices equipped in the offline stores 130-1 to 130-N. The POS devices of the offline stores 130-1 to 130-N may extract products related to the product information among products equipped in the offline stores 130-1 to 130-N using the product information received from the product information providing device 110. Further, the POS devices may generate a list using information of the products related to the product information and transmit the generated list to the product information providing device 110. In this case, the products which are sold in the offline stores 130-1 to 130-N through the POS devices are instantly recorded so that the information of the products included in the list may be managed in real time.

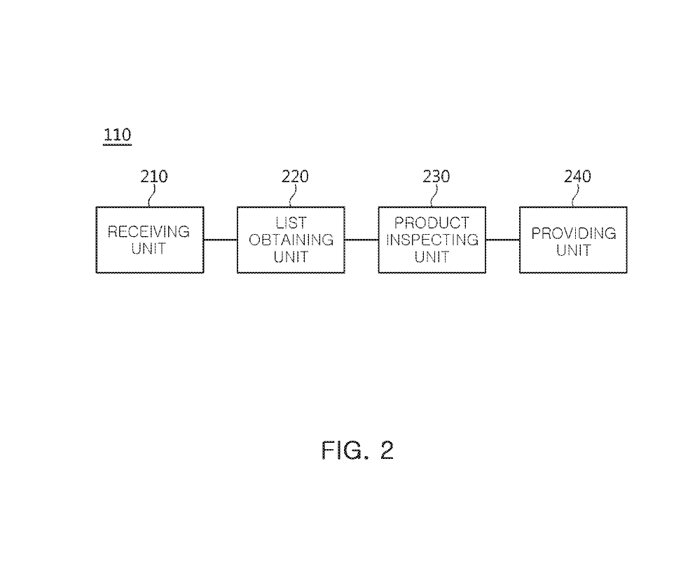

FIG. 2 is a block diagram illustrating a product information providing device of an offline store illustrated in FIG. 1.

Referring to FIG. 2, the product information providing device 110 of the offline store illustrated in FIG. 1 includes a receiving unit 210, a list obtaining unit 220, a product inspecting unit 230, and a providing unit 240.

The receiving unit 210 receives the information request message from the terminal device of the user. For example, when the user inputs information of a specific product through the terminal device to request a search, the product information providing device 110 may receive the information request message for the specific product transmitted from the terminal device.

The list obtaining unit 220 obtains a list of one or more products equipped in the offline store based on the product information included in the information request message. For example, when the user inputs the product through the terminal device, the user may input one or more product information of the product name, the product unique identification number, the barcode of the product, and the product image to request a search for the specific product. When the product information input as described above is transmitted to the POS device equipped in the offline store, the list obtaining unit 220 generates a list only with products registered in the POS device, that is, related to the product information, among products equipped in the offline store to provide the list to the product information providing device 110.

In this case, one or more offline stores may be searched based on product information within a predetermined area corresponding to search area information, using the search area information which is included in the information request message together with the product information. For example, the user selects a zone A on a map using the terminal device to search for a specific product which is sold in the zone A. In this case, the search area information on the area A and the product information are included in the information request message to be transmitted to the product information providing device 110. The product information providing device 100 sets a predetermined area using the received search area information and may search for one or more offline stores using the product information among offline stores registered in the product information providing device 110 in the predetermined area.

In this case, the offline stores in the predetermined area may be registered in advance in one or more of the product information providing device 110 and the database 111.

The product inspecting unit 230 inspects a list using an inspection item created based on the product information to extract effective products among products. For example, when the user searches for information of the specific product using the terminal device, various search results may be represented depending on a search keyword, a search image, and a search identification number input by the user. However, in some cases, an unrelated product which is totally different from the specific product which is wanted to be searched by the user may be searched. Therefore, the products included in the list are inspected through the inspection item in order to suppress an unnecessary search error, to extract only effective products which are desired by the user.

In this case, a product having a value of a list item corresponding to a main item of an inspection item in the list which is equal to a value of a main item may be extracted from the products as the effective product. For example, there may be several inspection items for inspecting the products. However, among these, important items which may surely distinguish the product may be designated as main items. Therefore, values of products corresponding to the main items among various items constituting the list are extracted. When the extracted values are equal to the values of the main items of the inspection item, the product is determined as an effective product which is desired to be searched by the user and the product may be extracted.

In this case, a product having a value of a list item corresponding to a general item of the inspection item in the list which is equal to a value of a general item may be extracted from the products as the effective product. For example, as described above, remaining items excluding the main items from the several inspection items may be designated as general items. The general items may not be important information to distinguish the product as compared with the main item. However, when the product included in the list is the same product as the product which is searched by the user, values of the products corresponding to the general item, among items constituting the list, may be equal to the value of the general item of the inspection item. Therefore, when the value of the general item of the products is inspected and is equal to the value of the general item of the inspection item, the products are determined as the effective products which are desired to be searched by the user to be extracted.

In this case, the inspection item may be constituted by a main item including one or more of a product name, a barcode number, and a product unique identification number and a general item including one or more of a released date, a product price, a manufacturer, a seller, a name of person in charge of releasing, and a product image. The values of the items included in the inspection item as described above may be determined through the product information received from the terminal device. For example, when the product information included in the information request message is searched by a network to extract a specific product and the inspection item may be generated using the information on the extracted product.

Further, one or more items included in the main item and the general item of the inspection item may be freely set by a manager of the product information providing device 110.

In this case, the value of the inspection item may be updated by comparing a value of a list item corresponding to one or more effective products registered in the database and the value of the inspection item. For example, the inspection item generated for the specific product is stored in the database and then may be used to inspect to the same product later. However, since the values of the inspection item for the corresponding product may be changed as time passes, the values of the inspection item need to be consistently updated. When the inspection item is updated by setting a predetermined period, if the stored inspection items are increased, system load may be caused. Therefore, when values of the general items of the effective products extracted using the main items of the inspection item are all the same during the inspection of the specific product but only the values of the general items of the inspection item are not same, the values of the general items of the inspection item may be changed to values of the general item of the effective products to be updated. In this case, the update may be performed only on items which may be changed, such as the product price or a discount rate, among the several inspection items.

In this case, among the products, a product having predetermined reference or more values of the list item corresponding to the inspection item in the list which are equal to the values of the inspection item may be extracted as a similar product.

In this case, in accordance with determination of a database manager, the similar product may be changed to any one of the effective product and a registration excluded product which is excluded from being registered in the database. For example, since the prices of the products may be continuously changed as time passes, when it is compared with the inspection item, the product may not be extracted as an effective product due to a price difference. In order to avoid the above-described case, when predetermined reference or more items are equal as compared with the various inspection items, the product is extracted as the similar product to be separately classified and directly determined by the product information providing device 110 and the manager of the database to be included as the effective product.

For example, when the number of inspection items is ten and the number of predetermined reference values is eight, eight or more list item values of the products corresponding to the inspection item match, the product is classified as a similar item and may be determined by the product information providing device 110 and the manager of the database. Obviously, as a result determined by the product information providing device 110 and the manager of the database, the product may be classified as a registration excluded product which is excluded from being registered in the database, rather than the effective product.

The providing device 240 registers the effective product in the database and transmits information on an effective offline store equipped with the effective product among one or more offline stores and information on the effective product to the terminal device. Products extracted as effective products are registered in the database so that when there is a request to search for the same product in the same area later, the information of the corresponding product may be provided without performing the inspection again. Further, when the information on the effective product is transmitted to the terminal device of the user, the information on the effective offline store in which the corresponding effective product is sold is also provided, so as to allow the user to easily visit the effective offline store.

In this case, effective offline store information including one or more of a location of the effective offline store, a phone number, an address, a photograph of the effective offline store, and subsidiary information of the effective offline store may be transmitted to the terminal device. The location, the phone number, and the address may be provided without searching for the location of the store by the user and the photograph of the store or the subsidiary information are provided so that more convenience service may be provided as compared when the offline store is used.

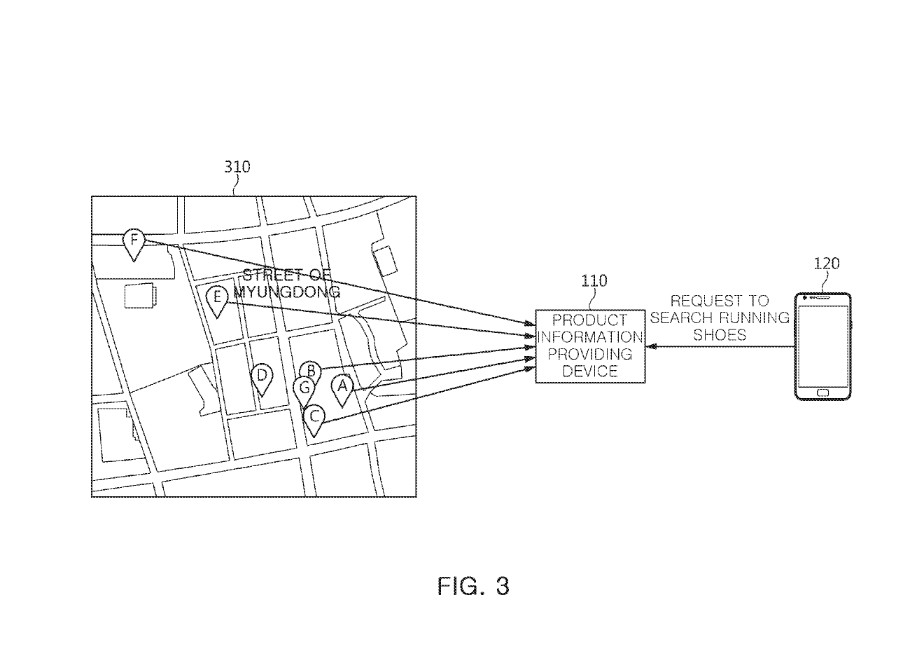

FIG. 3 is a view illustrating an example of searching for an offline store by an information request of a user according to an embodiment of the present invention.

Referring to FIG. 3, it is confirmed that the user requests the product information providing device 110 to search for running shoes, using the terminal device 120. In this case, one or more of a brand name of the running shoes, a product name of the running shoes, and an image of the running shoes are input to send an information request message to the product information providing device 110.

Further, a search area information indicating an area of the offline store in which the running shoes are sold and the product information are included in the information request message to be sent.

In FIG. 3, it may be assumed that an offline store in Myungdong in which running shoes are sold is searched.

In this case, the product information providing device 110 may search for seven offline stores A to G in which running shoes are sold, in the search area 310 which is Myungdong, using the product information and the search area information included in the information request message which is received from the terminal device 120.

In this case, lists generated based on the product information are obtained from the seven offline stores and the products included in the obtained list may be inspected with the inspection item generated based on the product information. As a result of inspecting the products included in the list, as illustrated in FIG. 3, information of the effective offline stores A, B, C, E, and F in which the effective products are sold is obtained to be registered in the product information providing device 110 together with the information on the effective product.

Thereafter, the product information providing device 110 may transmit the obtained information on the effective products and information on the effective offline stores to the terminal device 120 to be provided to the user.

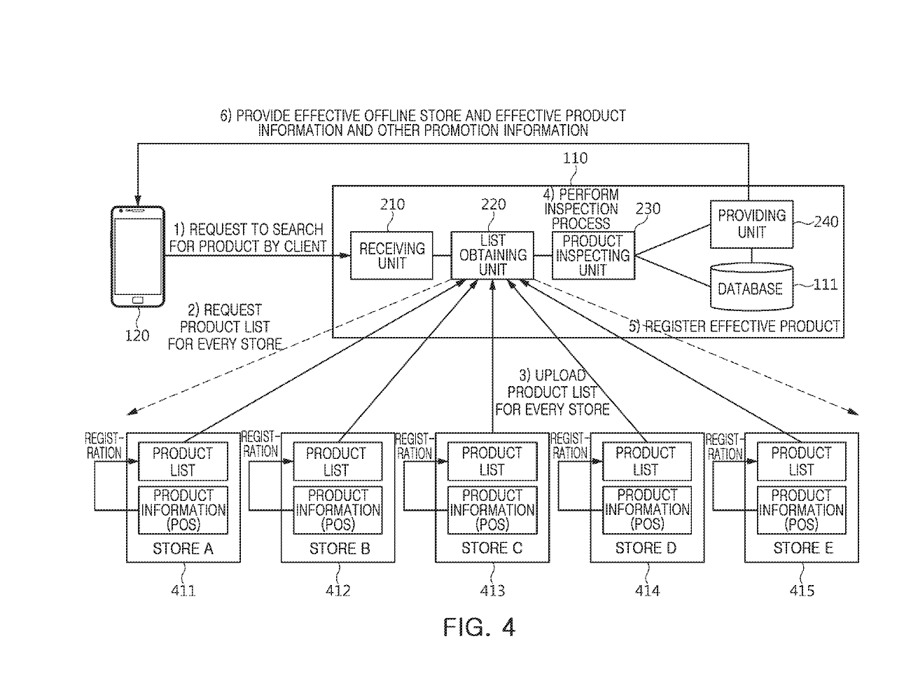

FIG. 4 is a view specifically illustrating a product information providing system of an offline store according to an embodiment of the present invention.

Referring to FIG. 4, a product information providing system of an offline store according to an embodiment of the present invention includes a product information providing device 110, a database 111, a terminal device 120, and offline stores 411 to 415.

The terminal device 120 receives a product search from the user, that is, a client to send a product search request to the product information providing device 110. In this case, the terminal device 120 transmits the information request message including product information on a product to be searched and search area information obtained by searching for the offline store to the product information providing device 110 to request a search.

The product information providing device 110 receives the information request message through the receiving unit 210 and may search for the offline stores 411 to 415 using the product information and the search area information included in the information request message received by the list obtaining unit 220.

The list obtaining unit 220 transmits the product information to the offline stores 411 to 415 to request the product list.

The offline stores 411 to 415 may generate a product list with products corresponding to product information among products registered in the POS device, based on the product information received from the product information providing device 110. The product list for every store generated by the offline stores 411 to 415 may be transmitted to the product information providing device 110.

Thereafter, the product inspecting unit 230 of the product information providing device 110 may inspect the obtained product list with the inspection item generated based on the product information.

Among products included in the product list for every store, effective products which are inspected by the product inspecting unit 230 are registered in the database 111 and provided to the terminal device 120 through the providing unit 240. In this case, information on the effective product, information on the effective offline store, and other promotion information may also be provided.

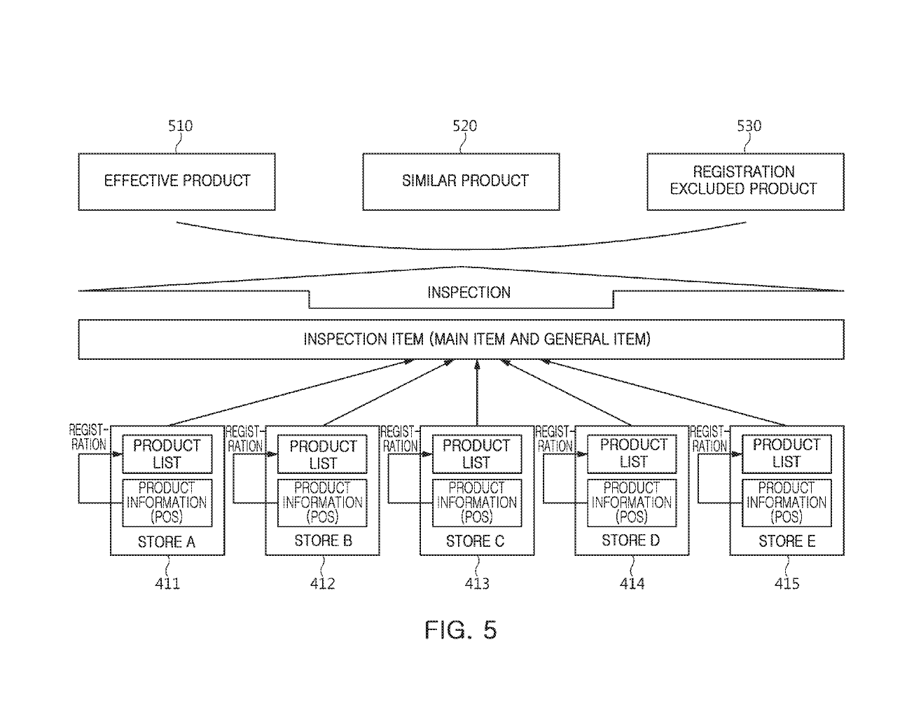

FIG. 5 is a view illustrating product classification in accordance with an inspection process according to an embodiment of the present invention.

Referring to FIG. 5, it may be confirmed that the products may be classified into an effective product 510, a similar product 520, and a registration excluded product 530 in accordance with an inspection process according to an embodiment of the present invention, as illustrated in FIG. 5.

The products included in the product lists obtained from the offline stores 411 to 415 may be inspected with an inspection item constituted by a main item and a general item.

In this case, one or more main items and one or more general items may be provided. When all values of the list items of the products included in the product list are equal to one or more values of the main item or one or more values of the general item, the corresponding product may be classified as the effective product 510. That is, a product having a value of the list item which is equal to the value of the inspection item may be classified as the effective product 510.

In this case, even though not all the values of the inspection items are equal to the values of the list items, when the product has predetermined reference or more values of the list item which are equal to the value of the inspection item, the product is classified as the similar product 520. The values of the list items of the products which are sold in the offline store may be changed as time passes. Therefore, even though the value of the list item may be different from the value of the inspection item, when predetermined reference or more values of the list item are equal to the values of the inspection item, the product is classified as the similar product 520 and then may be changed to the effective product 510 by determination of the product information providing device 110 and the manager of the database 111.

Further, products which are classified as the similar products 520, but are not determined as the effective products 510 by the product information providing device 110 and the manager of the database 111 are classified as registration excluded products 530 so as not to be registered in the database 111. Obviously, when values of the list items which are equal to the values of the inspection items are not more than the predetermined reference values during the inspection process, the products may be also classified as the registration excluded products 530.

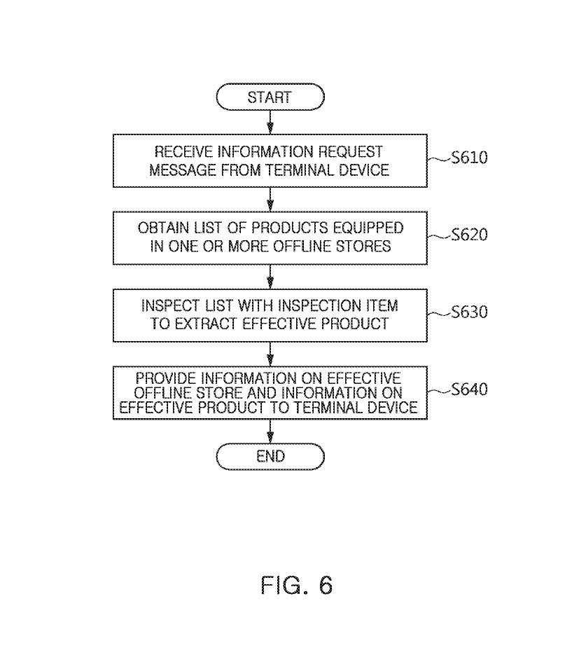

FIG. 6 is a flowchart illustrating an operation of a product information providing method of an offline store according to an embodiment of the present invention.

Referring to FIG. 6, in a product information providing method of an offline store according to an embodiment of the present invention, an information request message is received from a terminal device of the user (S610). For example, when the user inputs information of a specific product through the terminal device to request a search, the product information providing device may receive the information request message for the specific product transmitted from the terminal device.

Further, in the product information providing method of an offline store according to an embodiment of the present, a list of products equipped in one or more offline stores is obtained based on the product information included in the information request message (S620). For example, when the user inputs the product through the terminal device, the user may input one or more product information of the product name, the product unique identification number, the barcode of the product, and the product image to request a search for the specific product. When the product information input as described above is transmitted to the POS device equipped in the offline store, a list may be generated only with products registered in the POS device, that is, related to the product information, among products equipped in the offline store to provide the list to the product information providing device.

In this case, one or more offline stores may be searched based on product information within a predetermined area corresponding to search area information, using the search area information which is included in the information request message together with the product information. For example, the user selects a zone A on a map using the terminal device to search for a specific product which is sold in the zone A. In this case, the search area information on the zone A and the product information are included in the information request message to be transmitted to the product information providing device. The product information providing device sets a predetermined area using the received search area information and may search for one or more offline stores using the product information, among offline stores registered in the product information providing device in the predetermined area.

In this case, the offline stores in the predetermined area may be registered in advance in one or more of the product information providing device and the database.

Further, the product information providing method of an offline store according to an embodiment of the present invention inspects the list with the inspection item generated based on the product information to extract effective products from the products (S630). For example, when the user searches for information of the specific product using the terminal device, various search results may be represented depending on a search keyword, a search image, a search identification number, and the like input by the user. However, in some cases, an unrelated product which is totally different from the specific product which is wanted to be searched by the user may be searched. Therefore, the products included in the list are inspected through the inspection item in order to suppress an unnecessary search error, to extract only effective products which are desired by the user.

In this case, a product having a value of a list item corresponding to a main item of an inspection item in the list which is equal to a value of a main item is extracted as the effective product, among the products. For example, there may be several inspection items for inspecting the products. However, among these, important items which may surely distinguish the product may be designated as main items. Therefore, values of products corresponding to the main items among various items constituting the list are extracted. When the extracted values are equal to the values of the main items of the inspection item, the product is determined as an effective product which is desired to be searched by the user and the product may be extracted.

In this case, a product having a value of a list item corresponding to a general item of the inspection item in the list which is equal to a value of a general item may be extracted from the products as the effective product. For example, as described above, remaining items excluding the main items from the several inspection items may be designated as general items. The general items may not be important information to distinguish the product as compared with the main item. However, when the product included in the list is the same product as the product which is searched by the user, values of the products corresponding to the general item, among items constituting the list, may be equal to the value of the general item of the inspection item. Therefore, when the value of the general item of the products is inspected and the values of the products are equal to the value of the general item of the inspection item, the products are determined as the effective products which are desired to be searched by the user to be extracted.

In this case, the inspection item is constituted by a main item including one or more of a product name, a barcode number, and a product unique identification number and a general item including one or more of a released date, a product price, a manufacturer, a seller, a name of person in charge of releasing, and a product image. The values of the items included in the inspection item as described above may be determined through the product information received from the terminal device. For example, when the product information included in the information request message is searched by the network to extract a specific product and the inspection item may be generated using the information on the extracted product.

Further, one or more items included in the main item and the general item of the inspection item may be freely set by the manager of the product information providing device.

In this case, the value of the inspection item may be updated by comparing a value of a list item corresponding to one or more effective products registered in the database and the value of the inspection item. For example, the inspection item generated for the specific product is stored in the database and then may be used to inspect to the same product later. However, since the value of the inspection item for the corresponding product may be changed as time passes, the value of the inspection item needs to be consistently updated. When the inspection item is updated by setting a predetermined period, if the stored inspection items are increased, system load may be caused. Therefore, when values of the general items of the effective products extracted using the main items of the inspection item are all the same during the inspection of the specific product but the values of the general items of the inspection item are not same, the values of the general items of the inspection item may be changed to a value of the general item of the effective products to be updated. In this case, the update may be performed only on items which may be changed, such as the product price or a discount rate, among the several inspection items.

In this case, among the products, a product having predetermined reference or more values of the list item corresponding to the inspection item in the list which are equal to the value of the inspection item is extracted as a similar product.

In this case, in accordance with determination of a database manager, the similar product may be changed to any one of the effective product and a registration excluded product which is excluded from being registered in the database. For example, since the prices of the products may be continuously changed as time passes, when it is compared with the inspection item, the product may not be extracted as an effective product due to a price difference. In order to avoid the above-described case, when the product is compared with various inspection items and predetermined reference or more items are equal, the product is extracted as the similar product to be separately classified and directly determined by the product information providing device and the manager of the database to be included as the effective product.

For example, when the number of inspection items is ten and the number of predetermined reference values is eight, the number of list item values of the products which match values corresponding to the inspection item is eight or larger, the product is classified as a similar item and may be determined by the product information providing device and the manager of the database. Obviously, as a result determined by the product information providing device and the manager of the database, the product may be classified as a registration excluded product which is excluded from being registered in the database, rather than the effective product.

Further, the product information providing method of the offline store according to the embodiment of the present invention registers the effective product in the database and transmits information on an effective offline store equipped with the effective product among one or more offline stores and information on the effective product to the terminal device (S640). Products extracted as effective products are registered in the database so that when there is a request to search for the same product in the same area later, the information of the corresponding product may be provided without performing the inspection again. Further, when the information on the effective product is transmitted to the terminal device of the user, the information on the effective offline store in which the effective product is sold is also provided, so as to allow the user to easily visit the effective offline store.

In this case, effective offline store information including one or more of a location of the effective offline store, a phone number, an address, a photograph of the effective offline store, and subsidiary information of the effective offline store may be transmitted to the terminal device. The location, the phone number, and the address may be provided without searching for the location of the store by the user and the photograph of the store or the subsidiary information are provided so that more convenience service may be provided as compared when the offline store is used.

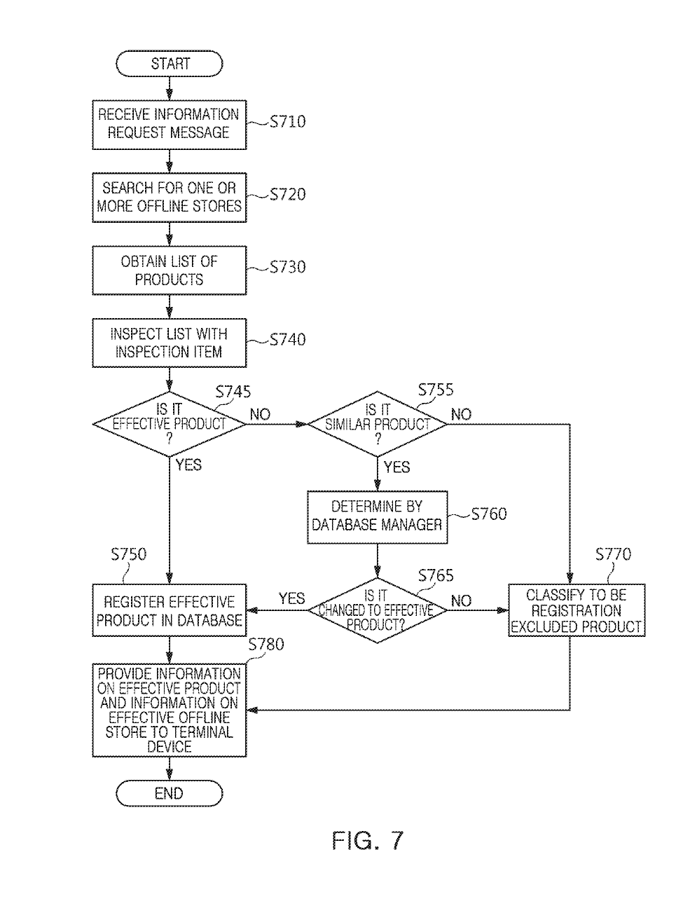

FIG. 7 is a flowchart specifically illustrating an operation a product information providing method of an offline store according to an embodiment of the present invention.

Referring to FIG. 7, a product information providing method of an offline store according to an embodiment of the present invention first receives an information request message from a terminal device of the user (S710).

Next, the product information providing method searches for one or more offline stores based on product information within a predetermined area corresponding to search area information, using the search area information which is included in the information request message together with the product information (S720).

Next, the product information providing method obtains a list of one or more products equipped in the offline store based on the product information included in the information request message (S730).

Next, the product information providing method inspects the list obtained from one or more offline stores with the inspection item generated based on the product information (S740).

Next, the product information providing method determines whether the inspected product is an effective product (S745).

When the inspected product is an effective product as a result of determination of step S745, the product information providing method registers the effective product in the database (S750).

When the inspected product is not the effective product as a result of determination of step S745, the product information providing method determines whether the inspected product is a similar product (S755).

When the inspected product is a similar product as a result of determination of step S755, the database manager determines how to classify the similar product to any of the effective product and a registration excluded product (S760).

Next, the product information providing method determines whether the similar product is changed to the effective product according to determination of the database manager (S765).

When the similar product is changed to the effective product as a result of determination of step S765, the product information providing method registers the effective product in the database (S750).

When the similar product is not changed to the effective product as a result of determination of step S765, the product information providing method classifies the inspected product as the registration excluded product (S770).

Further, when the inspected product is not a similar product as a result of determination of step S755, the product information providing method classifies the inspected product as the registration excluded product (S770).

Next, the product information providing method provides information on the effective product and information on the effective offline store in which the effective product is sold to the terminal device (S780).

The product information providing method of the offline store according to the embodiment of the present invention may be implemented as a program command which may be executed by various computers to be recorded in a non-transitory computer readable storage medium. The non-transitory computer readable storage medium may include solely a program command, a data file, and a data structure or a combination thereof. The program commands recorded in the medium may be specifically designed or constructed for the present invention or known to those skilled in the art of computer software to be used. Examples of the non-transitory computer readable storage medium include a magnetic media such as a hard disk, a floppy disk, or a magnetic tape, an optical media such as a CD-ROM or a DVD, a magneto-optical media such as a floptical disk, and any types of hardware devices which are specifically configured to store and execute the program command such as a ROM, a RAM, and a flash memory. Examples of the program command include not only a machine language code which is created by a compiler but also a high level language code which may be executed by a computer using an interpreter. The hardware device may operate as one or more software modules in order to perform the operation of the present invention and a reverse thereof is the same.

In the product information providing device and the product information providing method according to the present invention, the configuration and method of embodiments as described above may not be applied with limitation, but the embodiments may be configured by selectively combining all or a part of each embodiment such that various modifications may be made.

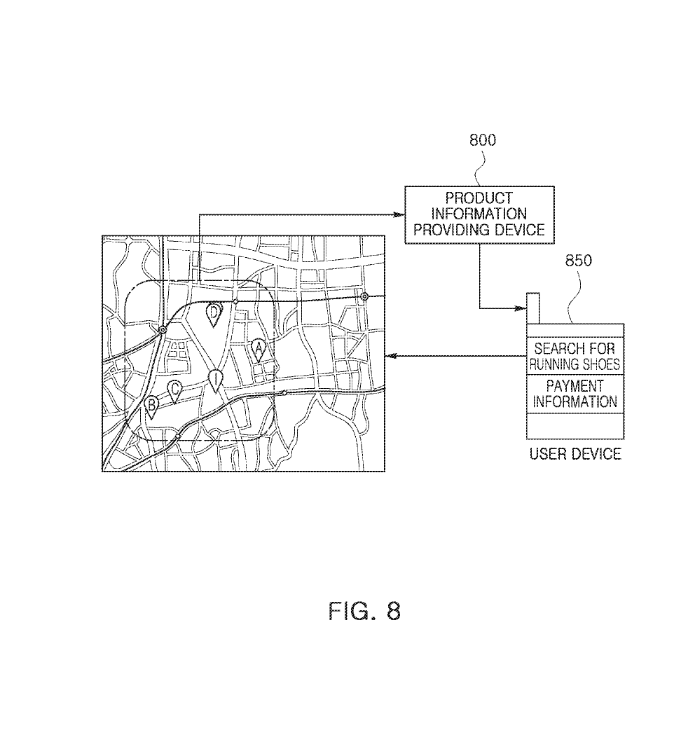

FIG. 8 is a conceptual view illustrating a method of providing product information based on a user device according to another embodiment of the present invention.

In FIG. 8, a method of providing information on a product which is purchasable in an offline store based on a user device 850 of a user, payment information of the product, and the like is disclosed.

Referring to FIG. 8, the user may search for a product using a user device in a predetermined zone where offline stores are concentrated. In this case, the product information providing device 800 may provide a store in which a product is sold, located near the user and payment information of a product to the user as product searching result information.

According to the embodiment of the present invention, a user device 850 transmits information (hereinafter, referred to as product payment related information, for example, payment card information, discount information, coupon information, or the like) related to the payment of the product to the product information providing device 800. Individual users may have different payment cards, coupons, and the like. Therefore, individual users may have different product payment related information which is transmitted to the product information providing device 800.

For example, when a user A and a user B search for the same product using their own user devices, the product information providing device 800 may provide different product search result information to the user device of the user A and the user device of the user B, respectively in consideration of the product payment related information of the user A and the product payment related information of the user B. Information which is provided by the product information providing device 800 in consideration of the product payment related information of the individual users may be referred to as product search result information. The product search result information is information which is provided to allow the user to purchase the product and may include information on a store in which the product is purchased, an expected payment amount, an expected accumulated amount, an expected discounted amount, detailed description information for a product to be purchased, and the like.

For example, a payment amount to purchase a product by the user A may be different from a payment amount to purchase a product by the user B. That is, the product information providing device 800 receives the product payment related information of the user A and the product payment related information of the user B and provides product search result information to the user device of the user A and the user device of the user B respectively in consideration of the product payment related information. For example, the product search result information which is provided to the user device of the user A may include information on an offline store close to the user A in which the product is sold, payment amount information expected when the user purchases the product in the offline store, detailed discount information expected when the user purchases the product, and the like.

Hereinafter, a commercial transaction method based on the product information providing device 800 and the user device 850 may be specifically described.

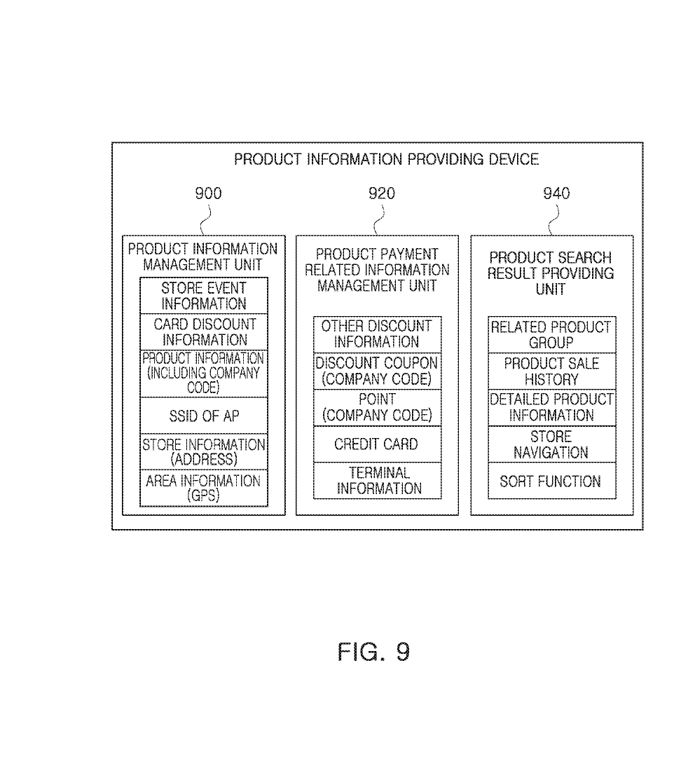

FIG. 9 is a conceptual view illustrating a product information providing device according to an embodiment of the present invention.

Referring to FIG. 9, the product information providing device includes a product information management unit 900, a product payment related information management unit 920, and a product search result providing unit 940.

The product information management unit 900 may be implemented to manage information on an offline store in which a product is sold and information on a product which is purchasable in the offline store. Some information of information managed by the product information management unit 900 is transmitted to the product search result providing unit 940 to provide product search result information to the user device.

The product information management unit 900 may receive information on the offline store, a product which may be purchased in the offline store, and the product payment related information from a server of a registered offline store, in real time or periodically.

Specifically, the product information management unit 900 may manage location information of the store based on a global positioning system (GPS) of each offline store, address information of each offline store, information on service set identifier (SSID) of an access point (AP) used in each offline store, as information on the offline store. The SSID of the AP is identification information of the AP installed in the offline store and used to obtain more precise location of the offline store. That is, information on the SSID of the AP may be used to determine whether to provide information related to the offline store to the user in consideration of a location between the offline store and the user device.

Further, the product information management unit 900 may manage product information including a company code, card discount information for the product, and store event information related to the product as information on a product which is purchasable in the offline store and product payment related information. The store event information related to a product may include not only price discount information for a product but also various event information such as an additional free gift or in-store promotion.

The product payment related information management unit 920 may be implemented to receive the product payment related information from the user device and manage the received product payment related information. For example, the product payment related information may include identifier information of the user device, credit card information which is available for the user, company point information which is accumulated by the user, discount coupon information for every company of the user, and other discount information of the user.

Specifically, the product payment related information management unit 920 receives information on electronic cash (a card, points, a discount coupon) stored in the user device as the product payment related information, from the user device. For example, the product payment related information management unit 920 obtains mobile payment information of the user device, through the user device, in real time. Alternatively, the product payment related information management unit maps purchase experience and possessed card information of the existing visited client to personal identifies (or an identifier of the user device) to be stored and then stores the purchase experience and possessed card information in the product payment related information management unit to be utilized when the user purchases a product.

Alternatively, card information for payment which is directly input through the user device by the user is transmitted to the product payment related information management unit 920 or the card information of the user may be provided to the product payment related information management unit through a card company server in association with a card company server.

The product payment related information management unit 920 may receive not only information on the payment as described above, but also preference information for a product of the user. For example, the product payment related information management unit 920 may map the product preference information such as an existing product search record and favorite setting record of the user to the user to be stored. Thereafter, the product preference information may be used to determine a recommended product or associated product information which will be transmitted to the user device in the product search result providing unit 940.

The product search result providing unit 940 receives product information from the product information management unit 900 and receives the product payment related information from the product payment related information management unit 920 to provide the product search result information to the user device.

The product search result information which is provided by the product search result providing unit 940 may include searched product information, associated product information, product sales history information, detailed product information (expected purchase price, discount information, or the like), and location information of a store in which a product is sold. In order to provide the product search result information connected to the card information, a unique identifier is mapped to a company which sells the product and the product to be connected to the card information.

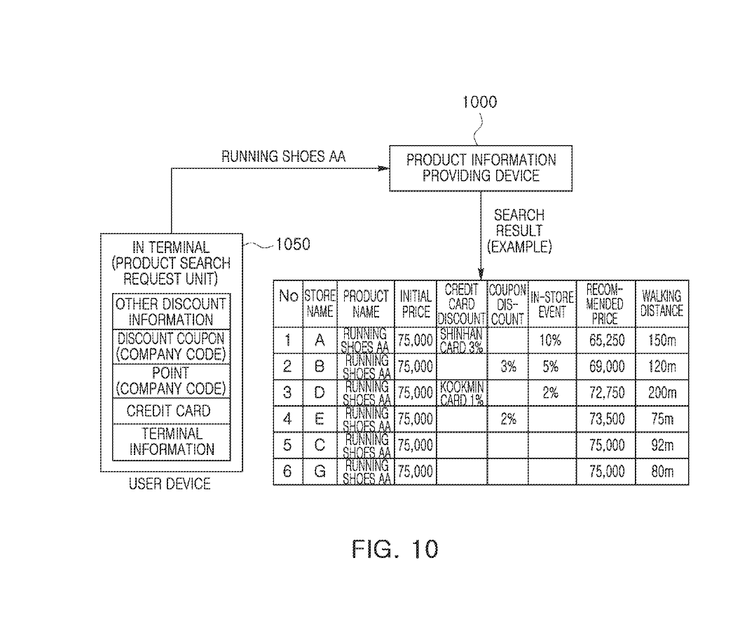

FIG. 10 is a conceptual view illustrating product searching result information according to an embodiment of the present invention.

In FIG. 10, product search result information which is provided by a product information providing device 1000 based on product payment related information transmitted from a user device 1050 is disclosed.

Referring to FIG. 10, the user device 1050 transmits product payment related information and product information to be searched to the product information providing device 1000. The product information providing device 1000 may transmit product search result information based on the product payment related information to the user device 1050.

When a product searched by the user device 1050 is “running shoes AA”, product search result information corresponding to the “running shoes AA” may be transmitted to the user device 1050.

The product search result information may include a name of a store in which the running shoes AA can be purchased, an initial price of the running shoes AA, card discount information of the running shoes AA, coupon discount information of the running shoes AA, an in-store event for the running shoes AA, recommended price information of the running shoes AA, and information on a walking distance of the running shoes AA.

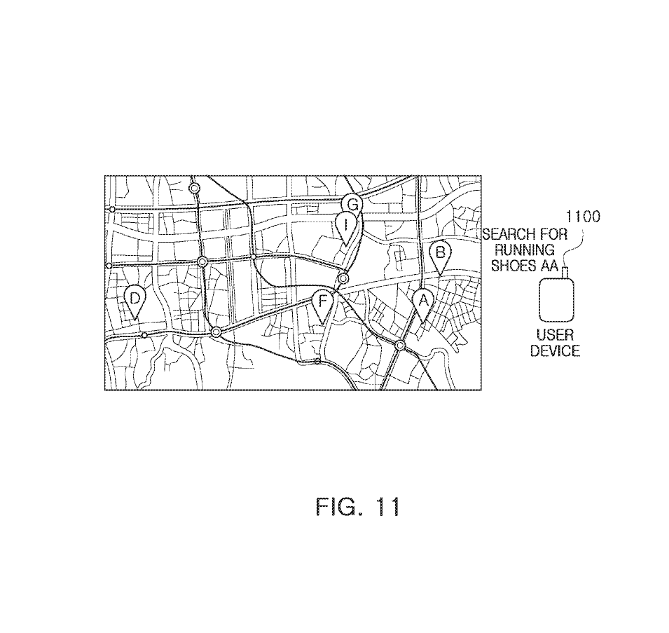

FIG. 11 is a conceptual view illustrating product searching result information according to an embodiment of the present invention.

In FIG. 11, information on a store in which a product is sold is provided based on map information.

Referring to FIG. 11, the product information providing device may provide information on a location of a product selling store and expected payment amount information for every product selling store, among product search result information, together with map information.

The product information providing device may transmit map information including a location of the product selling store which is located within a predetermined range from a position of a user device 1100 and expected payment amount information for every product selling store, by means of the user device 1100, as product search result information. The user may determine a movable distance to which the user may move to purchase a product by means of the user device 1100. The product information providing device may provide information on an offline store in which a product is sold in consideration of the movable distance to the user device 1100.

The user may purchase a product in consideration of the location of the product selling store and the expected payment amount for every product selling store.

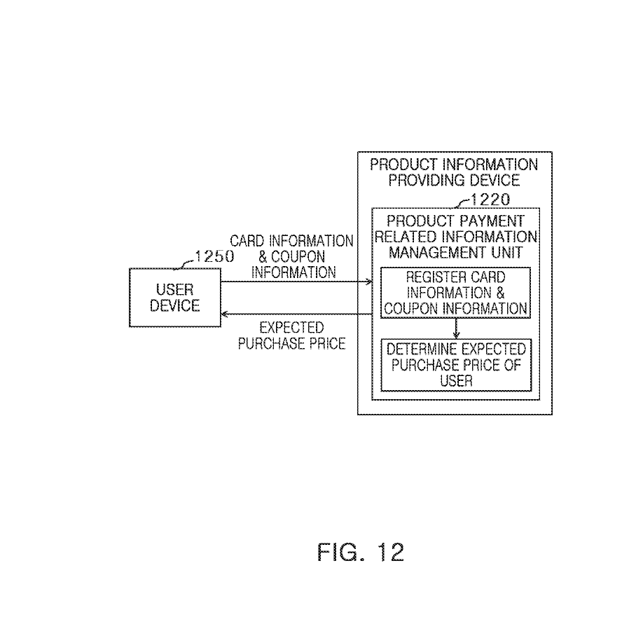

FIG. 12 is a conceptual view illustrating an operation of a product payment related information management unit according to an embodiment of the present invention.

In FIG. 12, a method of obtaining card information for payment of the user and coupon information by a product payment information management unit 1220 will be disclosed.

Referring to FIG. 12, the product payment information management unit 1220 may request the user device to register available card information and coupon information.

The user device 1250 may register currently available card information to the product payment information management unit 1220. The user device 1250 may transmit a card image obtained by photographing the card to the product payment information management unit 1220. The product payment information management unit 1220 obtains a card type and card number information based on the photographed card image. For example, the product payment information management unit 1220 may obtain number information of the photographed card image by image analysis.

A subsequent payment procedure is performed based on the card number registered in the product payment information management unit 1220, so that a procedure of separately inputting a card number by the user may be omitted. The user may register and use an additional passcode for a payment procedure for an additional security setting.

The user may input information on a subscribed site to the product payment information management unit 1220 in order to obtain available coupon information. The product payment information management unit 1220 extracts only coupon information related to a product to be purchased by the user from the site and then transmit the coupon information to the user device. The user downloads a coupon based on the provided coupon information and then purchases the product using the coupon. According to the embodiment of the present invention, the user may register information for accessing a previously subscribed site in the product payment information management unit 1220 to directly download the coupon information by means of the product payment information management unit 1220.

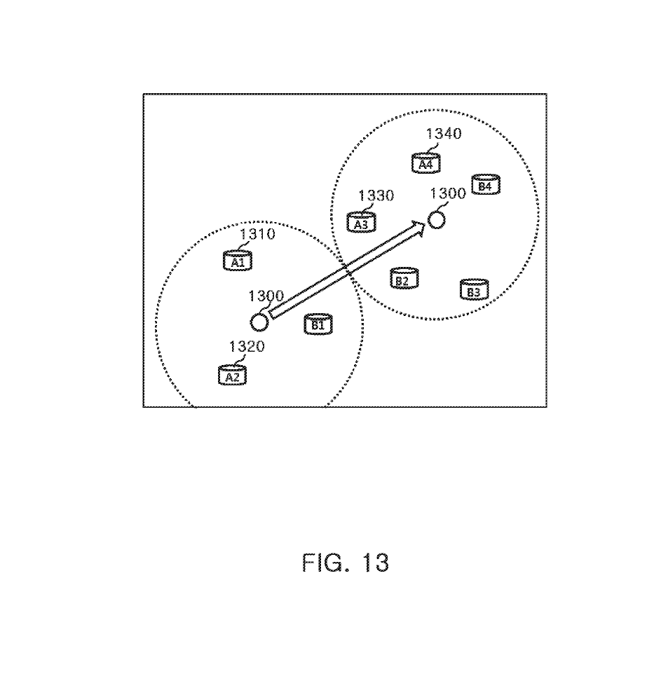

FIG. 13 is a conceptual view illustrating a product purchasing method according to an embodiment of the present invention.

In FIG. 13, disclosed is a method of transmitting information on an offline store in which a product is sold, close to the user 1300, by means of the user device when a user 130 inputs a product to be purchased by means of a product purchasing application of a user device and then go around a predetermined area.

Referring to FIG. 13, when the user 1300 wants to purchase shoes X of a company A, the user executes a product purchasing application and then may input a product name X of the corresponding product in a product purchase list. Thereafter, when the user 1300 moves to a specific area, the product information providing device may determine whether to purchase the product recorded in the product purchase list in an offline store close to the user. For example, when the user is in a first area, the user may be provided with information on stores A1 1310 and A2 1320 in which the shoes X may be purchased. When the user is in a second area, the user may be provided with information on stores A3 1330 and A4 1340 in which the shoes X may be purchased.

That is, the product which is input by the user may be periodically searched in accordance with the position change of the user and information on a store in which the product is purchasable is provided to the user.

The user sets a movable distance to purchase a product, by means of the product information providing device and is provided with information on offline stores which are included in different ranges from the product information providing device in accordance with the set movable distance.

For example, the product information providing device may determine a product purchasable store which is a store in which the shoes X of a company A is sold. Thereafter, a close product purchasable store which is within a predetermined range from a current position of the user may be determined among the product purchasable stores.

The product information providing device may transmit information on the close product purchasable store through the user device. By using the above-described method, the user may obtain information on a store in which the product is sold, during the movement.

When a plurality of products is stored in the product purchase list by the user and the user may purchase at least two products among the plurality of products in a close position, the product information providing device may provide optimal route information to purchase two products.

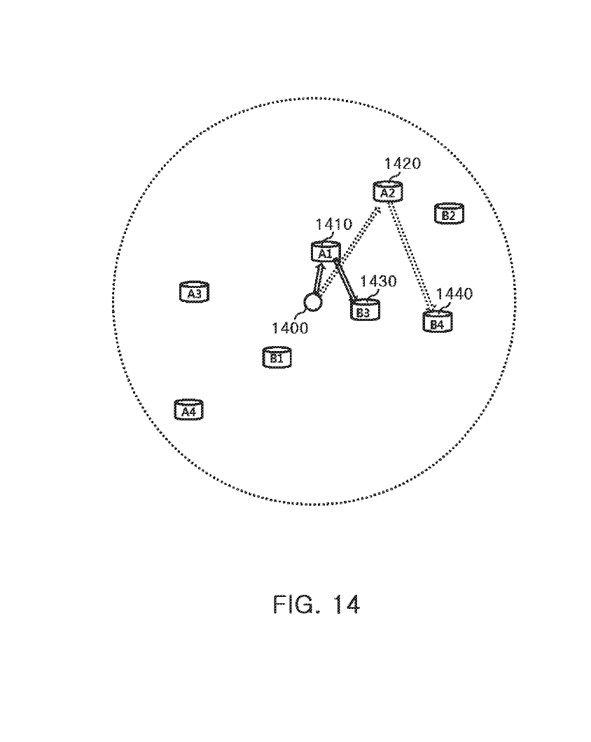

FIG. 14 is a conceptual view illustrating a product purchasing method according to an embodiment of the present invention.

In FIG. 14, it is disclosed that a plurality of products is included in a product purchase list and the user 1400 is provided with information on a plurality of offline stores for purchasing the plurality of products from a product information providing device.

Referring to FIG. 14, it is assumed that a product A and a product B are included in the product purchase list of a user 1400 and the user may purchase the product A and the product B within a close distance range set by the user.

The product information providing device may provide optimal purchase route information to purchase the product A and the product B to the user 1400. The optimal purchase route information is a route between one store of a plurality of stores in which the product A is sold (hereinafter, referred to as a product A selling store) and one store of a plurality of stores in which the product B is sold (hereinafter, referred to as a product B selling store). The optimal purchase route may be determined in consideration of a product sale price of the plurality of product A selling stores, a distance between a current position of the user 1400 and the plurality of product A selling stores, a product sale price of the plurality of product B selling stores, a distance between the current position of the user 1400 and the plurality of product B selling stores, distance between the plurality of product A selling stores and the plurality of product A selling stores, and a converted amount for a distance set by the user 1400.

The converted amount for distance may be considered to determine the optimal purchase route in consideration of the difference between purchase price, regardless of the shortest purchasable distance and a distance difference. The converted amount for distance may be a correction value of the purchase amount according to a distance difference for determining an optimal route.

For example, in consideration of the position of the user 1400, the product A and the product B are purchased in the product A selling store 1 1410 and the product B selling store 3 1430, the user 1400 may purchase the product A and the product B through a shortest route. When the user purchases the product A in the product A selling store 1 1410 and purchases the product B in the product B selling store 3 1430, an expected cost to be paid by the user may be 12000 won.

When the product A and the product B are purchased in a product A selling store 2 1420 and a product B selling store 4 1440, the user 1400 may purchase the product A and the product B through a distance which is 100 m longer than the shortest route. When the user purchases the product A in the product A selling store 2 1420 and purchases the product B in the product B selling store 4 1440, an expected cost to be paid by the user may be 10,000 won.

In this case, the product information providing device may determine an optimal route in consideration of the converted amount for distance set by the user 1400. When the converted amount for distance set by the user 1400 is 1000 won per 100 m, the optimal product purchase route may be a route in which the product A is purchased in the product A selling store 2 1420 and the product B is purchased in the product B selling store 4 1440. When the converted amount for distance set by the user 1400 is 3000 won per 100 m, the optimal product purchase route may be a route in which the product A is purchased in the product A selling store 1 1410 and the product B is purchased in the product B selling store 3 1430.

That is, the optimal route may be determined by comparing an expected payment cost when the products are purchased through the shortest route and a value obtained by adding an expected payment cost when the products are purchased through a route other than the shortest route and a value obtained by multiplying a distance difference from the shortest route and the converted amount for distance.

The optimal route determining method as described above may also be applied when the user purchases one product. When the user purchases one product, the optimal product purchasing route may be determined in consideration of the current position of the user, sale amount of a plurality of close product purchasable stores, and a converted amount for distance.

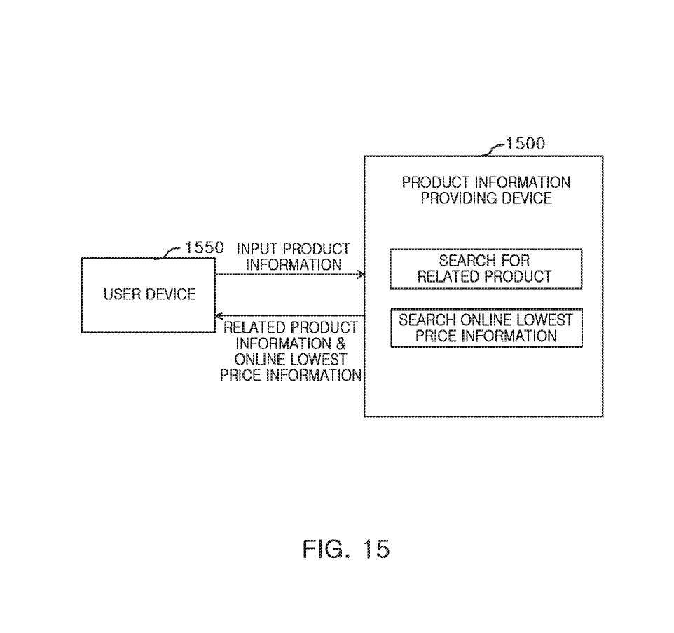

FIG. 15 is a conceptual view illustrating a product information providing server according to an embodiment of the present invention.

In FIG. 15, a method of recommending real-time Internet lowest price information and another product in a product information providing device 1500 will be disclosed.

Referring to FIG. 15, when a user inputs product information or information on an offline store in which the product is purchased, the product information providing device 1500 provides a real-time Internet product purchasable price through a window having a predetermined size. By using the above-described method, the user may be provided with more sale information to purchase a product and also provided with information on a price to be paid at the time of purchasing an online product through the Internet without searching the information through a separate window.

Further, the product information providing device 1500 may transmit related product information related to a product which is input by the user to a user device 1550 in real time. The related product information may be product information which is provided to another user in the corresponding position within a predetermined period as a product in the same category as the product input by the user. Specifically, it is assumed that a user 1 inputs product information to the product information providing device 1500 in a first area where the user 1 wants to purchase a shoes X of a company A. The product information providing device 1500 may provide a shoes Y of a company B which is a different product in the same category input by a different user 2 in the first area within a predetermined period (for example, one month) to the user 1 as related product information.

If necessary, the user 1 may use a related product searching function and in this case, the product information providing device 1500 may provide information on an offline store in which the shoes Y of the company B is purchasable and a sale price to the user 1. In this case, the product information providing device 1500 may further provide information on an optimal route when the product X of the company A is purchased and information on an optimal route when the product Y of the company B is purchased.

The product information providing device, the product information providing method, and the product information providing system according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the product information providing device and the user device according to the embodiment of the present invention to implement a synchronizing method.

The non-transitory computer readable storage medium includes a magnetic storage medium, an optical storage medium, and a carrier wave medium. The computer program implementing the product information providing device, the product information providing method, and the product information providing system according to the embodiment of the present invention may be stored and installed in embedded memories of the user device. Alternatively, external memories such as a smart card storing and installing the computer program implementing the product information providing device, the product information providing method, and the product information providing system according to the embodiment of the present invention may be installed on the user device through an interface.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

### INDUSTRIAL APPLICABILITY

According to the present invention, it is possible to receive an information request message from a terminal device of a user, obtain a list of products equipped in one or more offline stores based on product information included in the request message, extract an effective product from the products by inspecting the list with an inspection item generated based on the product information, register an effective product in a database, and provide information on an effective offline store equipped with an effective product among one or more offline stores and information on the effective product to the terminal device. Furthermore, information on products which are frequently demanded by clients that is, frequently traded is constructed in the database, so that an offline or online seller modifies promotion and sales strategy using the database information to more actively sell the product in the store and thus product sales records in the store may be increased.

Furthermore, according to the present invention, information on an offline store in which a user purchases a desired product with respect to a position of the user is provided and information on an expected payment amount for every user when the user purchases a product in an offline store is provided in consideration of payment information for every user (for example, payment card information or coupon information). Further, information on an optimal route to allow a user to purchase a product on the offline is provided and the user makes a payment on the product through a simpler procedure. Therefore, the present invention may be widely used in a user service providing field, a marketing field, or the like.

1. A product information providing device of an offline store, the device comprising:
a receiving unit which receives an information request message from a terminal device of a user;
a list obtaining unit which obtains a list of one or more products equipped in the offline store based on the product information included in the information request message;
a product inspecting unit which inspects the list with an inspection item generated based on the product information to extract an effective product from the products; and
a providing device which registers the effective product in the database and transmits information on an effective offline store equipped with the effective product among one or more offline stores and information on the effective product to the terminal device.

2. The device of claim 1, wherein the product inspection unit extracts a product having a value of a list item corresponding to a main item of the inspection item in the list which is equal to a value of the main item as the effective product, among the products.

3. The device of claim 2, wherein the product inspecting unit extracts a product having a value of the list item corresponding to the general item of the inspection item in the list which is the same as the value of the general item as the effective product, among the products.

4. The device of claim 3, wherein the inspection item is constituted by a main item including one or more of a product name, a barcode number, and a product unique identification number and a general item including one or more of a released date, a product price, a manufacturer, a seller, a name of person in charge of releasing, and a product image.

5. The device of claim 4, wherein the product inspecting unit compares the value of the list item corresponding to one or more effective products registered in the database and the value of the inspection item to update the value of the inspection item.

6. The device of claim 1, wherein the list obtaining unit searches for one or more offline stores based on the product information within a predetermined area corresponding to the search area information using the search area information which is included in the information request message together with the product information.

7. The device of claim 1, wherein the providing unit transmits information on the effective offline store including one or more of a location of the effective offline store, a phone number, an address, a photograph of the effective offline store, and subsidiary information of the effective offline store to the terminal device.

8. The device of claim 5, wherein the product inspecting unit extracts a product having predetermined reference or more values of the list item corresponding to the inspection item in the list which is equal to the values of the inspection item as a similar product, among the products.

9. The device of claim 8, wherein the product inspecting unit changes the similar product to any one of the effective product and a registration excluded product which is excluded from being registered in the database in accordance with determination of a database manager.

10. A product information providing method of an offline store, the method comprising:
receiving an information request message from a terminal device of a user;
obtaining a list of one or more products equipped in the offline store based on the product information included in the information request message;
extracting an effective product from the products by inspecting the list with an inspection item generated based on the product information; and
registering the effective product in the database and transmitting information on an effective offline store equipped with the effective product among one or more offline stores and information on the effective product to the terminal device.

11. The method of claim 10, wherein in the extracting, a product having a value of a list item corresponding to a main item of the inspection item in the list which is the same as the value of the main item is extracted as the effective product, among the products.

12. The method of claim 11, wherein in the extracting, a product having a value of a list item corresponding to a general item of the inspection item in the list which is the same as the value of the general item is extracted as the effective product, among the products.

13. The method of claim 12, wherein the inspection item is constituted by a main item including one or more of a product name, a barcode number, and a product unique identification number and a general item including one or more of a released date, a product price, a manufacturer, a seller, a name of person in charge of releasing, and a product image.

14. The method of claim 13, wherein in the extracting, the value of the list item corresponding to one or more effective products registered in the database is compared with the value of the inspection item to update the value of the inspection item.

15. The method of claim 10, wherein in the obtaining of a list, one or more offline stores are searched based on the product information within a predetermined area corresponding to the search area information using the search area information which is included in the information request message together with the product information.

16. The method of claim 10, wherein in the transmitting, information on the effective offline store including one or more of a location of the effective offline store, a phone number, an address, a photograph of the effective offline store, and subsidiary information of the effective offline store is transmitted to the terminal device.

17. The method of claim 14, wherein in the extracting, a product having predetermined reference or more values of the list item corresponding to the inspection item in the list which are equal to values of the inspection item is extracted as a similar product, among the products.

18. The method of claim 17, wherein the extracting includes:
changing the similar product to any one of the effective product and a registration excluded product which is excluded from being registered in the database in accordance with determination of a database manager.

19. A non-transitory computer readable storage medium having a computer program recorded thereon configured to perform the method of claim 10.

20. A product information providing system of an offline store, the system comprising:
a product information providing device which receives an information request message and obtains a list of products equipped in one or more offline stores based on product information included in the message, extracts an effective product from the products by inspecting the list with an inspection item generated based on the product information, and provides information on an effective offline store equipped with the effective product among one or more offline stores and information on the effective product; and
a terminal device which transmits the information request message to the product information providing device based on an input of the user and receives information on the effective offline store and information on the effective product corresponding to the information request message from the product information providing device.

21-32. (canceled)
